(19) United States
(12) Patent Application Publication
(10) Pub. No.: US 2006/0276967 A1
(43) Pub. Date: Dec. 7, 2006

(54) Method and apparatus for collecting and distributing beach water quality alerts

(76) Inventor: Chris J. Warner, Scottsdale, AZ (US)

Correspondence Address: BINGHAM MCCUTCHEN LLP, 3000 K STREET, NW, BOX IP, WASHINGTON, DC, 20007, US

(21) Appl. No.: 11/144,602

(22) Filed: Jun. 6, 2005

(51) Int. Cl. G06F 19/00

(52) U.S. Cl. 702/2; 702/30

(57) ABSTRACT

Information on beach water quality (and water quality generally) is collected and stored in a relational database with geographic information, such as zip codes. Information on the water quality of particular beaches is formatted and provided to the public through a website. In addition, subscribers may sign up to receive alerts on the water quality of particular beaches when the water quality status of each particular beach changes. A handheld device, wirelessly or manually, may be used by water monitors to collect and upload water information to a remote server to facilitate making water quality information available to the public in real time. The server may collect and format the information to fulfill local and federal reporting requirements.

### FIELD OF THE INVENTION

The present invention relates to a system and method for collecting, processing, distributing to the public alert information concerning beach water quality on particular beaches.

### BACKGROUND OF THE INVENTION

The water quality at beaches, including ocean beaches, is presently monitored to some degree today. The Environmental Protection Agency in the United States has guidelines for the monitoring, collecting and reporting of beach water quality. However, at present, there is no comprehensive process for aggregating this information and making it available to the public and to make it available in a timely manner. Accordingly, there is a need for water quality information to be provided on a timely basis to anyone who desires it.

### SUMMARY OF THE INVENTION

Information on beach water quality (and water quality generally) is collected and stored in a relational database with geographic information, such as zip codes. Information on the water quality of particular beaches is formatted and provided to the public through a website. In addition, subscribers may sign up to receive alerts on the water quality of particular beaches when the water quality status of each particular beach changes.

According to one embodiment of the invention, a method of generating water quality alerts includes receiving water quality information from an agency having a predetermined format, translating the emergency information into different formats associated with a plurality of different devices and transmitting the formatted emergency information to each of the respective plurality of different devices. The method may include storing location information identifying user devices that are associated with alerts affecting water in different localities. The method may further include determining at least one affected locality associated with water information and translating and transmitting the water alert to each user device having location information associated with the affected locality. The affected locality may be a particular beach, a particular body or water or source of water.

According to another embodiment of the invention, a method of handling water quality information includes collecting water quality information at particular localities, storing the information according to a predetermined format and transmitting the water quality information to a server for distribution as water quality alerts to a plurality of devices.

According to another embodiment of the invention, a method of distributing water quality information to the public includes: receiving information identifying at least one user device on which to receive water quality alerts regarding particular localities; receiving water quality information from an agency having a predetermined format; translating the emergency information into another format usable by each of the user devices; and transmitting the translated water information as an alert to the devices when particular conditions are met. The user device may be a wireless device such as a wireless telephone or electronic mail reader or a computer or a standard land phone line.

According to another embodiment of the invention, a system for handling the distribution of water quality alerts may include an user alert database, a water information database and a server. The user alert database is accessible via a network that stores information identifying user devices and localities. The water information database accessible via the network that stores water quality information. The server is coupled to the databases and allows users to access and identify user devices and localities. The server also allows agencies to provide water information for use in generating water quality alerts.

### BRIEF DESCRIPTION OF THE FIGURES

The above described features and advantages of the present invention will be more fully appreciated with reference to the detailed description and figures, in which:

FIG. 1 depicts a functional block diagram of a system for collecting information on beach water quality and making the information available for an alert process and for other purposes according to an embodiment of the present invention.

FIG. 2 depicts a method of registering a user to receive beach water quality alerts according to an embodiment of the present invention.

FIG. 3 depicts a method of generating beach water quality alerts according to an embodiment of the present invention.

FIG. 4 depicts an illustrative block diagram of a system for collecting beach water quality information according to an embodiment of the present invention.

FIG. 5 depicts a reporting process according to an embodiment of the present invention.

### DETAILED DESCRIPTION

Information on beach water quality (and water quality generally) is collected and stored in a relational database with geographic information, such as zip codes. Information on the water quality of particular beaches is formatted and provided to the public through a website. In addition, subscribers may sign up to receive alerts on the water quality of particular beaches when the water quality status of each particular beach changes.

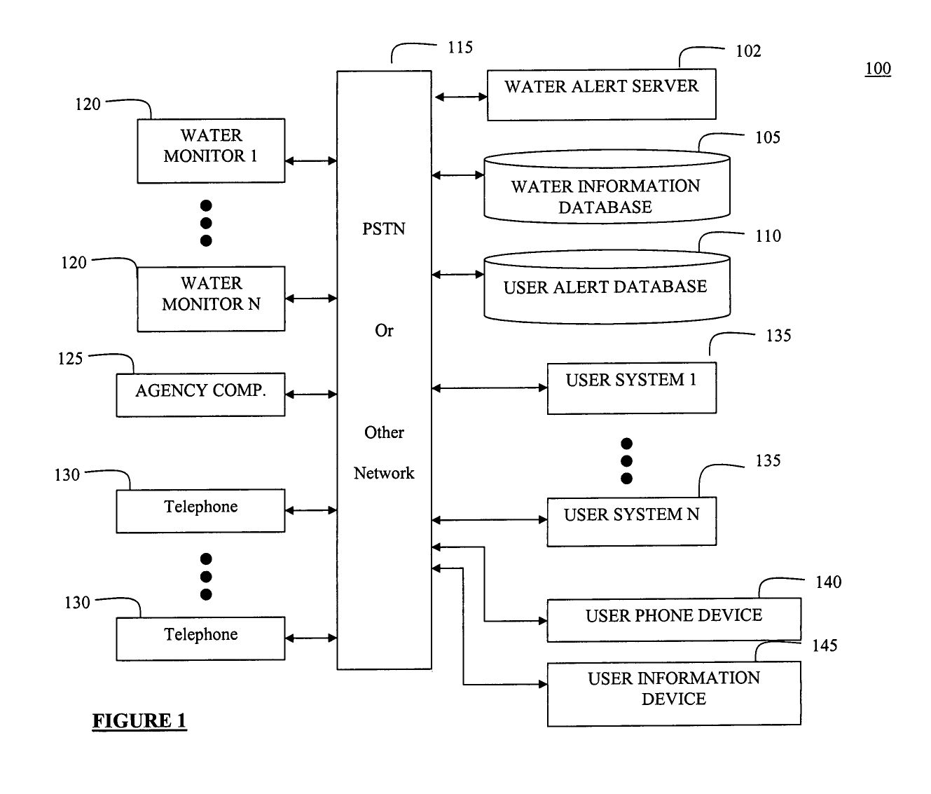

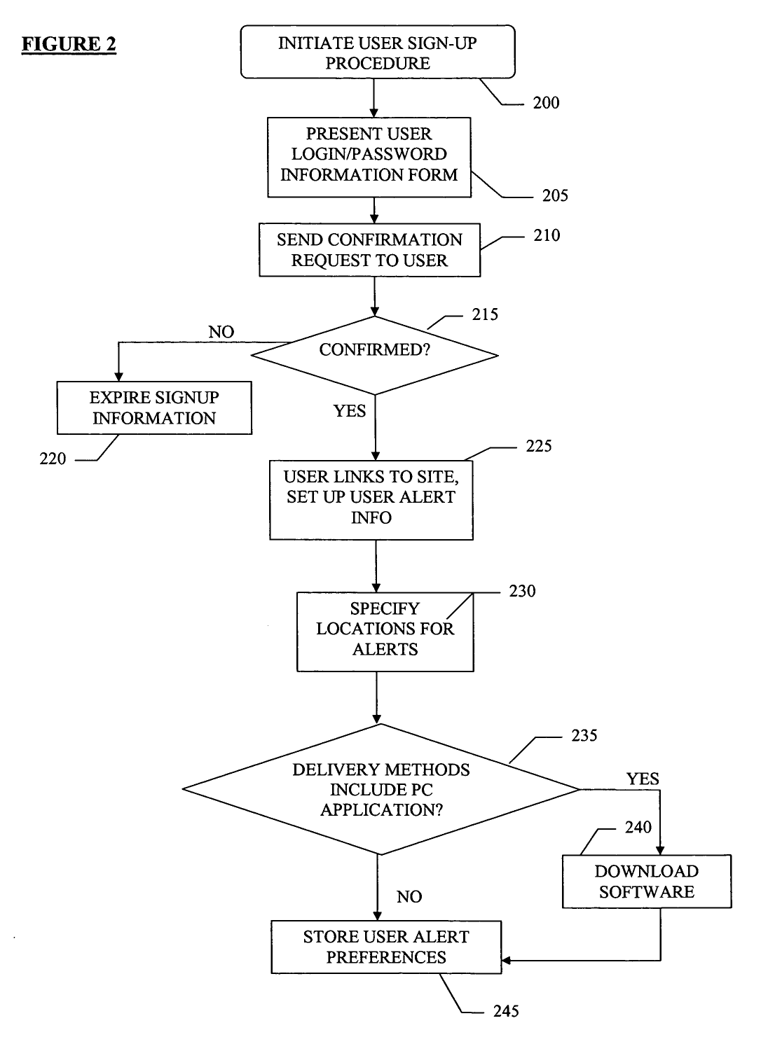

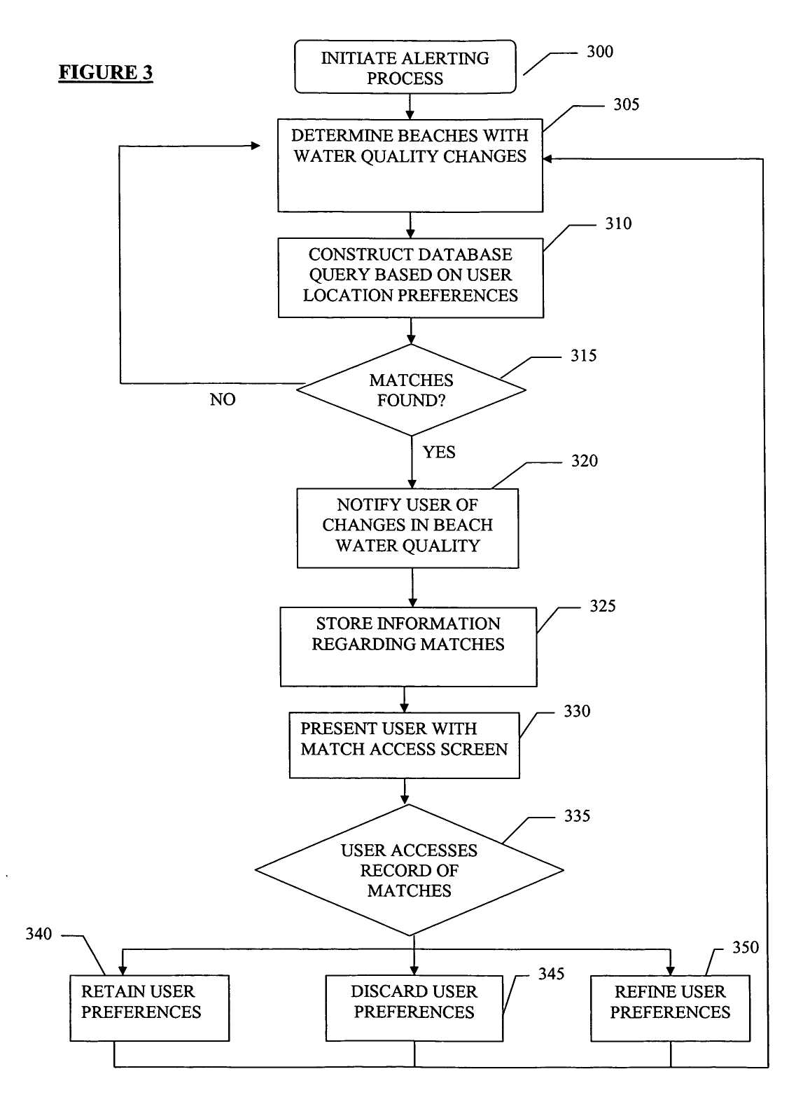

FIG. 1 depicts a functional block diagram of a system 100 for collecting water information and making the information available for a water quality alert process and for other purposes according to an embodiment of the present invention. FIG. 1 is discussed initially to provide an overview of the different aspects of the system 100 for collecting information and defining and generating alerts. The processes for defining alerts and for generating alerts are discussed in more detail below with reference to FIGS. 2 and 3.

Referring to FIG. 1, beach water quality information is collected and stored in a beach information database 105 coupled to a network 115 via an alert server 102. Also coupled to the network 115 and used to provide information to the beach information database 105 are computers at one or more beach monitoring station 120, one or more agency computers 125, and a plurality of telephones 130. In addition, user systems 135 are coupled to the network 115 to allow users to define beaches about which they would like to receive alerts as discussed further below. In addition, user mobile telephone and other wireless or wired devices 140 and 145 may be coupled to the network to receive alerts. A user alert database 110 is used to store user information and alert information defined by users as discussed in more detail below.

The server 102 may be any general purpose computer, including a server, and may be used to facilitate the interaction between members of the public, who are interested in water quality information, and agencies that collect information about water quality. According to one embodiment of the invention, the server interacts with user and the databases 105 and 110 in order to produce web pages that are accessible over the Internet and in order to carry out off-line processing used in generating the alerts. With respect to the web pages, the server may generate web pages that: (i) allow a user to sign up for water quality alerts with respect to particular beaches; (ii) allow a user to sign up for water quality alerts with respect to particular localities for example by zip code.

The water information database 105 is a relational database that stores information about the water quality for each beach or other area that is monitored by the system 100. Generally, the water information may be associated with an address or a zip code. The beach or area may be assigned an identification number to facilitate storage and retrieval of water quality information with respect to particular beaches are areas, although this is not necessary. The water information database may further include time information associated with each water measurement represented in the water information database 105. The database may store all water information that it receives. Alternatively, the database 105 may maintain only the current conditions or a certain number of the recent measurements for each beach or other location.

The user alert database is a relational database and includes information about users that are interested in receiving water quality alerts. In general, the alert database allows a user to register with the server 102, identify an email address and also devices through which the user desires to receive water quality alerts. Each device may operate according to a different protocol. Accordingly, the database identifies the type of devices through which the user desires to receive water quality alerts, such as a mobile phone 140 or other information device 145. The server includes software that in turn allows it to translate water information from the water information database to a format and a protocol suitable for each permitted device registered for a particular user.

For example, when the user selects a mobile device, the user information may include a mobile phone number and a mobile provider to properly configure a SMS message. When the user selects an email address or a text message, an email or text message may be generated, for example, by the mail function of PHP. When an alert application resident on the user's computer is selected, the user's computer may check a link on the website to determine from the link whether there is any information matching water quality alert criteria.

The computers 120 and 125 may each be a server or other general purpose computer that runs computer programs. In general, the computers 120 and 125 are used to collect information on water quality, such as such as beach closures information and warnings due to severe pollution or warnings that, for instance, bacteria levels are too high. The computers 120 and 125 are used to automatically upload the information to the water information database 105. The water information may refer to the beach or an individual testing station on a particular beach where the measurement was taken, and any other information desired. The information may be uploaded to the database 105 in any convenient manner including sending a file having water information; sending information in email to a contact person who maintains the alert server 102 and water information database 105; entering information directly into a database server that serves up the information via a IVR (interactive voice response) system, webpage served by the server 102 or in any other convenient manner.

The telephones 130 may also be used as a source of water information. For this purpose, a user may call a telephone number to specify a beach or other location about which water alerts or information is desired. The information received over the telephones 130 may be taken by a person or an interactive voice response unit which prompts the user to enter location information. This information in turn may be entered into the database 105 by operators in the case of live operators or, in the case of an IVR unit, may be sent to the water information database 105 over the network 115 in order to retrieve alerts or water information with respect to the beach or location inquired about.

The PSTN or other network 115 (and any other network described herein) may be a local area network, a wide area network, the public switched telephone network, the interconnected backbones, routers, bridges, switches and servers known as the Internet, other communications links and combinations thereof. The network may include direct electrical connections, wireless, optical or any other communications links, including analog, digital, circuit switched and packet switched, for transmitting information.

The user system 135 may be a general purpose computer system, a server, a personal digital assistant or any other device or hand held device that permits the exchange of information via the network 115 with the server 102. According to one embodiment of the invention, the user system 135 is a general purpose computer that executes computer software, including browser software, which permits the display of web pages generated by the server 102. The system 135 may also permit the exchange of information between the server 102 and input/output devices associated with the system 135. The user system 135 may be used by the user to sign up to receive alerts for particular beaches or particular localities, for example by zip code, or to otherwise interact with information available from the server 102 and the associated databases.

FIG. 2 depicts a method of registering a user to receive water quality alerts according to an embodiment of the present invention. Referring to FIG. 2, the user visits a web site and initiates the sign-up procedure 200. The user is then presented with a form in step 205 requesting login information, such as a user identification and a password. The form may also request an e-mail address. In step 210, a confirmation of registration request is sent to the e-mail address specified in step 205. If the user declines confirmation, either by active refusal or by neglecting to respond, the sign-up information provided for the user may expire, for example, after a period of time in step 220.

According to one embodiment of the invention, the user may confirm registration by selecting a link embedded in a confirmation email to the user. If the user selects the link, this confirms the user's registration in step 215 and may direct the user to a website where the user is presented with a form used to set up alert information for the user in step 225. The alert information may include, for example, particular beaches, zip codes, addresses or other locations at which the user desires to receive alerts regarding water quality. The alert information may further include one or more methods of notification and/or devices through which the user desires to receive alerts, for example, via e-mail, a text message to a cell phone, a message sent to a downloadable PC application, or the like.

The user may then be presented with a form in step 230 that allows the user to specify alert information about beaches or locations about which the user is searching for water information or alerts. The information may further include time and/or date information specifying a period during which the user would like to receive alerts or a time and/or date after which the user no longer wishes to receive water alert information. The entry of information may be accomplished in any convenient manner, including by selecting from a form available over the Internet that includes a list of options. For example, a form may be filled out to specify a set of attributes (i.e., particular beaches in a particular county, water alerts in particular zip codes, a calendar of dates to allow time and date constraints.

According to one embodiment of the invention, a user may select to receive a notification by the user's computer interacting with the server. If this is the case, in step 235, the user's computer may download a software application in step 240 via the network 115 from, for example, the server 102 or other convenient site. The software application may interact with the server 102 to generate alerts to the user of the computer when a water alert is issued that matches a person's criteria, by checking the database 105 on a periodic basis, such as hourly, or when the database 105 is updated. After step 240, step 245 begins. In step 245, at the end of the notification selection process, the user's alert preferences are saved 245 in the user alert database 110. This alert information may then used by the server 102 to conduct regular searches of the water information database for each beach or locality selected by the user for generate alerts search criteria are met, i.e. when the alert status changes or when the time and date criteria are met or when other water quality conditions are met.

FIG. 3 depicts a method of generating alerts according to an embodiment of the present invention. The alert process in general may be an automated process that initiates at specific times or at periodic intervals, for example, every thirty minutes. Alternatively, it may be asynchronous, or may be invoked in any other manner. In general, the alerts should be issued in a timely fashion, a relatively short period of time after a water quality alert is received in the water information database 105.

Referring to FIG. 3, according to an embodiment of the present invention, the alert process begins at step 300. In step 305, the system then determines which users, if any, have active alert requests (i.e. request alert information with respect to the water quality of particular beaches or with respect to the water in particular localities). The preferences of the user are extracted and converted into a database search query 310 for each search that has not yet expired, either by a date set by the user or a date set by the system (i.e. six months from date of registration). The results are then analyzed, and, in step 315 if no matches are found, the system moves on to the next active search. If a match is found in step 315, the user is notified in step 320 according to the notification method(s) specified by the user. In general, a match may be found when the water quality of a particular beach or in a particular location requested by the user changes or when the user first registers for water quality information for particular beaches or locations. Other criteria may also form the basis for an alert to be sent, including that a particular water quality measure passes a threshold. This depends upon the amount of water quality information available at each beach and/or location. The user may be notified by the server transmitting an alert to a user's computer, to an email address, or to a user's mobile telephone or other wireless device. In this manner, information on the water quality of beaches and other bodies of water is put into possession of the public.

In step 325, particular beaches or locations (or their identifiers) corresponding to beaches that match the user's specifications may be stored. Users may, in general, check the website to see a list of beaches or other bodies or water or water sources that have an alert status. Other information about water quality and how to control water quality may also be provided through the website to encourage responsible personal and corporate practices.

When the user logs into the website, the user may be presented with a match access screen in step 330. The user may access the record of matches (for example, the five different beaches that have had a beach alert status change), and may be presented with a set of options. For example, the user may be able to scroll through a map of different geographic areas counties with different beaches or other bodies or sources of water with their alert status shown. The user may discard certain bodies of water identified in step 345, disabling future alerts regarding particular beaches or locations. Or, the user may refine, alter or set up a new search in step 350 to select additional or different beaches or locations about which to receive alerts or refine time periods with respect to each beach or other location.

After the options in step 340-350 are taken, the alert process may terminate until invoked again. In this manner, water alerts are generated for the public based on up to date, real time water information collected by different agencies with respect to different beaches, bodies or water and/or water sources.

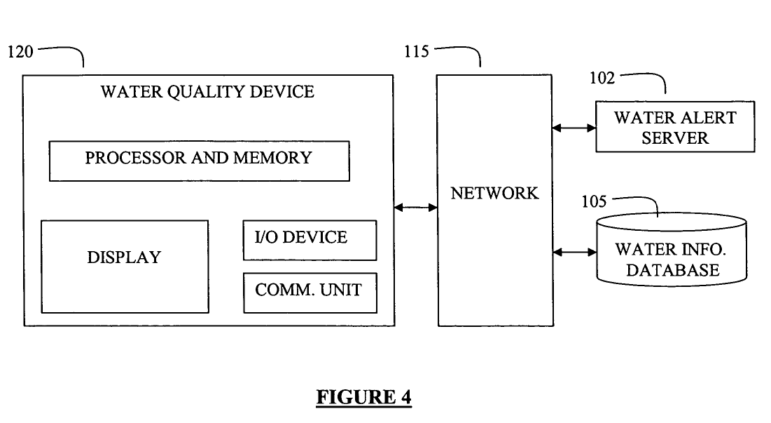

FIG. 4 depicts a device for monitoring beach water quality and reporting the beach water quality information to a database. Referring to FIG. 4, the device is a handheld device including a processor and memory, a screen and a keyboard, a pointing device or other input device. The device further includes a communications unit which may be used to establish wireless or wired communication through the network 115 with the water information database 105 and/or server 102. In general, the device is portable and may be carried by individuals who are performing beach water quality measurements, or water quality measurements generally with respect to any body of water or water source. The device may include a browser that is able to communicate with the server 102 in order to display a webpage form that includes water quality fields that the water quality monitoring person may complete. By so entering data through a portable, wireless device, the monitor provides real time information to the water information database in a format that the water information database can use to instantly make available water information and alerts to the public according to the processes described herein.

Alternatively, the device may include its own program that facilitates the entry of water quality information by a water quality monitor. The program may display a menu or otherwise may be browser driven and permits data to be entered quickly and efficiently and ensures that the water information is stored in a predetermined format. This water information may then be uploaded by the device periodically, after an update or at other times in order to provide the most recently available information to the water information database.

In both cases, water monitors may carry the device with them so that as they are measuring water quality at particular beaches or in particular locations, the monitor has a device/software into which he or she can enter information that is then uploaded promptly to a database manually or wirelessly that is made available to the public for alerts or for general use.

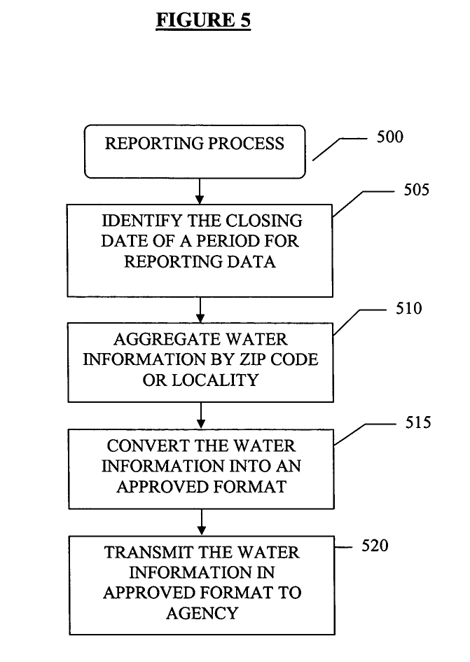

FIG. 5 depicts a process of reporting water information according to an embodiment of the present invention. Referring to FIG. 5, the server references data in step 505 to determine reporting intervals for reporting water information to state, local or regional agencies. The intervals may be specified to be yearly by a particular date, quarterly, monthly, weekly or any other convenient interval. In step 510, at some point after the close of the collection interval, the server may generate a report by aggregating the water information collected by zip code or locality. In step 515, the water information is converted into an approved format, such as an XML format approved by the Environmental Protection Agency. In step 520, the water information in the approved format may be transmitted or otherwise made available to state, local or federal agencies to satisfy reporting requirements. Thus, the server 102 may be used by localities not only to put the public in possession of certain water quality information, but also to satisfy various reporting requirements.

While particular embodiments of the present invention have been illustrated and described herein, it will be understood that changes may be made to those embodiments without departing from the spirit and scope of the present invention. For example, it will be understood that the processes of FIGS. 2, 3 and 5 may be implemented in computer program instructions that cause the server 102 to perform the steps indicated. In addition, the order of the steps shown may be changed in FIGS. 2, 3 and 5.

What is claimed is:

1. A method of water quality alerts, comprising:
receiving water quality information from an agency having a predetermined format;
translating the emergency information into different formats associated with a plurality of different devices; and
transmitting the formatted emergency information to each of the respective plurality of different devices.

2. The method of claim 1, further comprising:
storing location information identifying user devices that are associated with alerts affecting water in different localities; and
performing the translating and transmitting with respect to each user device.

3. The method of claim 2, further comprising:
determining at least one affected locality associated with water information; and
performing the translating and transmitting with respect to each user device having location information associated with the affected locality.

4. The method accord to claim 3, wherein the affected locality is a particular beach.

5. A method of handling water quality information, comprising:
collecting water quality information at particular localities;
storing the information according to a predetermined format;
transmitting the water quality information to a server for distribution as water quality alerts to a plurality of devices.

6. The method according to claim 5, wherein the water quality information includes information identifying when the quality of water exceeds a threshold.

7. The method of claim 5, further comprising:
receiving water quality information from a plurality of portable electronic devices via a network.

8. The method of claim 7, wherein the particular localities include particular beaches.

9. A method of distributing water quality information to the public, comprising:
receiving information identifying at least one user device on which to receive water quality alerts regarding particular localities;
receiving water quality information from an agency having a predetermined format;
translating the emergency information into another format usable by each of the user devices; and
transmitting the translated water information as an alert to the devices when particular conditions are met.

10. The method according to claim 9, wherein the at least one user device is a wireless device.

11. The method according to claim 15, wherein the wireless device is a mobile telephone.

12. A system for handling the distribution of water quality alerts, comprising:
an user alert database accessible via a network that stores information identifying user devices and localities;
a water information database accessible via the network that stores water quality information;
a server coupled to the databases that allowing users to access and identify user devices and localities and that allows agencies to provide water information for use in generating water quality alerts.

13. The system according to claim 12, wherein the server further includes software that translates water information stored in a predetermined format into a plurality of different formats associated with different devices.

14. The system according to claim 13, wherein one of the formats includes a web page format associated with a URL for providing water quality information.

15. The system according to claim 13, wherein one of the formats includes an electronic mail format for providing water information alerts to devices by electronic mail.

16. The system according to claim 13, wherein one of the formats includes at least one wireless device format for providing water quality information.

17. The system according to claim 16, the at least one wireless device includes a mobile telephone and at least one of the formats involves the use of a land line telephone.

18. The system according to claim 13, wherein one of the formats is a XML format approved by the Environmental Protection Agency.

19. The system according to claim 14, and provides to authorities fulfilling Federal, and state reporting requirements.
